(19) United States
(12) Patent Application Publication
(10) Pub. No.: US 2016/0162985 A1
(43) Pub. Date: Jun. 9, 2016

(54) OCCUPANCY MONITORING FOR A REMOTE SHORT TERM HOUSING RENTAL

(71) Applicant: Mazen Alhakim, Cape Coral, FL (US)

(72) Inventor: Mazen Alhakim, Cape Coral, FL (US)

(21) Appl. No.: 14/561,257

(22) Filed: Dec. 5, 2014

(51) Int. Cl. G06Q 30/06; H04M 1/725; G06Q 50/16

(52) U.S. Cl. CPC G06Q 30/0645; G06Q 50/163; H04M 1/72569; H04M 1/7253

(57) ABSTRACT

The present invention includes a system, comprising a network, a rental status monitor located within a dwelling, and at least one portable computing device. The rental status monitor communicates a status signal via the network to the portable computing device to alert a user of a status of occupancy of a dwelling. The rental status monitor further comprises a transceiver, a sensing unit configured to detect and analyze a dwelling to determine occupancy; and a controller configured to verify the detected occupancy. The controller, upon detection and analysis of the occupancy by the sensing unit, verifies the detected occupancy by evaluating at least one detected sound or at least one detected volume, identifying an occupancy status based on the evaluation, and creating the status signal based on the identification; and wherein the controller authorizes the transceiver to send the status signal to the at least one portable computing device.

### CROSS-REFERENCE TO RELATED APPLICATION

This application is a continuation-in-part (CIP) of U.S. Non-Provisional patent application Ser. No. 14/475,604 filed Sep. 3, 2014, which is incorporated by reference herein.

### FIELD OF THE INVENTION

The invention relates to the field of remote monitoring of a rental status, whether or not a rental unit is occupied and/or vacant, of remote short term housing rentals.

### BACKGROUND OF THE INVENTION

A short term housing rental could come in different forms such as, time share, condo, beach property, cabin, vacation property, motel, skiing resort and other resort areas.

The owners of these properties live away from them, in some cases out of state, which means the owners need to hire a property manager to manage the daily rentals of these short term rentals. Being away from these properties, the owners have no idea of the daily rental status frequency; the property manager could easily rent the unit and pocket the rental income without the owner's knowledge.

What is needed therefore is a Wi-Fi monitoring system installed at the property communicating with the owner's smart phone and that will resolve this issue by keeping eye at the property and provide the owner with a solid track of the daily rental status.

### BRIEF SUMMARY OF THE INVENTION

It is, therefore, an object of the present invention to provide a remote occupancy monitoring system.

An exemplary environment for the present invention can include, but is not limited to, a structure, such as a residential abode or a commercial facility or any other structure where a system including a rental status monitor is functionally necessary.

In an exemplary embodiment of the present invention, a system to monitor occupancy in a housing rental can include, but is not limited to, a network, a rental status monitor, and at least one portable computing device.

In one exemplary aspect of the present embodiment, the rental status monitor can be located within a dwelling.

In another exemplary aspect of the present embodiment, the rental status monitor can communicate a status signal via the network to the at least one portable computing device to alert a user of a status of occupancy of the dwelling.

The following are additional and/or exemplary aspects of this exemplary embodiment, one or more of which can be combined with the basic invention as embodied above:
the rental status monitor can further comprise:
   a transceiver configured to send and receive the status signal to at least one portable computing device via the network;
   a sensing unit configured to detect and analyze a dwelling to determine occupancy;
   a controller configured to verify the detected occupancy;
   the controller, upon detection and analysis of the occupancy by the sensing unit, can verify the detected occupancy by evaluating at least one detected sound or at least one detected volume, can identify an occupancy status based on the evaluation, and can create the status signal based on the identification; and
   the controller authorizes the transceiver to send the status signal to the at least one portable computing device;
the sensing unit can further comprise:
   an audio detector which can be configured to detect at least one audio tone created within the dwelling where the rental status monitor is located; and
   an audio recognizer which can be configured to identify the at least one audio tone as a tone from a human or animal;
the audio recognizer can be configured to identify the at least one audio tone as a tone from a human or animal and can further comprise:
   analyzing a detected audio tone for at least one spatio-temporal property compared to a library of spatio-temporal property audio tones;
   comparing the detected audio tone to a library of attack vectors to determine if an active deception is occurring;
   creating a positive status signal if comparisons determine a human or animal and also creating a positive status signal if comparisons determine an active deception; and
   creating a negative status signal if comparisons determine no audio tone which is at least one spatio-temporal property of a human or animal;
the audio detector comprises one or more sensing elements which can be removably attached to physical elements within the dwelling;
the sensing unit can further comprise:
   a volume detector which can be configured to detect at least one volume located within the dwelling where the rental status monitor is located; and
   a volume recognizer configured to identify the at least one volume as a volume created from a human or animal;
the volume recognizer can be configured to identify the at least one volume of a human or animal, further comprising:
   analyzing a detected volume for at least one spatio-temporal property attributed to a human or animal compared to a library of spatio-temporal property volumes;
   comparing the detected volume to a library of attack vectors to determine if an active deception is occurring;
   creating a positive status signal if comparisons determine a human or animal and also creating a positive status signal if comparisons determine an active deception; and
   creating a negative status signal if comparisons determine no volume which is at least one spatio-temporal property of a human or animal;
the volume detector can comprise one or more sensing elements which are removably attached to physical elements within the dwelling;
the rental status monitor can further comprise a processor that is configured to communicate with the at least one portable computing device via the network;
the rental status monitor can further comprise a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols.

An additional exemplary embodiment of the present invention can further include a non-transitory computer readable storage medium having computer executable instructions, the computer executable instructions when installed onto a rental status monitor cause the rental status monitor to perform actions.

One exemplary action which the computer executable instruction can cause a rental status monitor to perform can include detecting an at least one audio tone or an at least one volume within a dwelling where the rental status monitor is located.

Another exemplary action which the computer executable instruction can cause a rental status monitor to perform can include verifying and analyzing the at least one audio tone or the at least one volume;

Yet still another exemplary action which the computer executable instruction can cause a rental status monitor to perform can include identifying the at least one audio tone or the at least one volume as having at least one spatio-temporal property of a human or an animal.

A further exemplary action which the computer executable instruction can cause a rental status monitor to perform can include configuring a status signal from identified at least one audio tone or the at least one volume such that it is transmittable to at least one or more user devices via a network.

Yet still a further exemplary action which the computer executable instruction can cause a rental status monitor to perform can include sending and receiving the at least status signal to and from the at least one or more user devices and the rental status monitor via the network.

The following are additional and/or exemplary actions which the computer executable instructions can cause a rental status monitor to perform, one or more of which can be combined with the basic invention as embodied above:
detecting the at least one audio tone can further comprise:
   analyzing a detected audio tone for at least one spatio-temporal property compared to a library of spatio-temporal property audio tones;
   comparing the detected audio tone to a library of attack vectors to determine if an active deception is occurring; and
   creating a positive status signal if comparisons determine a human or animal and also creating a positive status signal if comparisons determine an active deception; creating a negative status signal if comparisons determine no audio tone which is at least one spatio-temporal property of a human or animal;
detecting the at least one volume can further comprise:
   analyzing a detected volume for at least one spatio-temporal property attributed to a human or animal compared to a library of spatio-temporal property volumes;
   comparing the detected volume to a library of attack vectors to determine if an active deception is occurring;
   creating a positive status signal if comparisons determine a human or animal and also creating a positive status signal if comparisons determine an active deception; and
   creating a negative status signal if comparisons determine no volume which is at least one spatio-temporal property of a human or animal.
configuring the status signal can further comprise:
   modulating the audio tone to a digital signal which is transmittable via a network; or
   reconfiguring a volume image to a digital signal which is transmittable via a network; and
   transmitting the status signal as one of a plurality of status signals to and from an intermediate computing device, the at least one or portable computing devices, and the rental status monitor via the network.
sending and receiving the status signal to the at least one or more portable computing devices and the rental status monitor via the network can further comprise a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols;
sending and receiving the status signal to the at least one or more portable computing devices and the rental status monitor via the network can further comprise a transceiver configured to communicate wirelessly using at least one infrared frequency, said transceiver configured to send and receive the status signal according to IrDA-SIR, IrDA-MIR, and IrDA-FIR protocols;
sending and receiving the status signal to the at least one or more portable computing devices and the rental status monitor via the network can further comprise a transceiver configured to authenticate wirelessly, and can further comprise:
   encrypting the at least status signal;
   initiating wireless communication with a wireless communication device;
   authenticating the wireless communication device using a private authentication key to authenticate the user's identity;
   identifying the originating source of the status signal to determine if an active deception is occurring; and
   sending the encrypted status signal upon positive authentication of the wireless communication device;
verifying and analyzing the at least one data item entered by the user further comprises:
   comparing the detected audio tone or the detected volume to a matrices of stored data libraries, wherein the matrices of stored data libraries can further comprise audio tones and volumes which correlate to spatio-temporal properties of a human or animal, stored so that all information is accessible to the controller at such time that the detecting units senses said audio tone or said volume;
   configuring the status signal such that it is transmittable to the at least one or more portable computing devices via the network can further comprise storing the at least one data item to a memory in the rental status monitor; and
sending and receiving the status signal to and from the at least one or more portable computing devices and the rental status monitor via the network can further comprise transmitting a communication with the transmitted status signal that is displayed on the one or more portable computing devices as a GPS location of the audio tone or volume, based on at least one collected geographic data collected by the sensing unit.

These and other exemplary aspects of the present invention are described herein.

Those skilled in the art will recognize still other aspects of the present invention upon reading and understanding the attached description

### BRIEF DESCRIPTION OF THE DRAWINGS

The present invention is illustrated by way of example, and not in limitation, in the figures of the accompanying drawings.

For a better understanding of the present invention and its embodiments, reference will be made to the following detailed description, which is to be read in association with the accompanying drawings.

FIG. 1 illustrates is a system diagram of one embodiment of an occupancy monitoring system for a remote short term housing rental, in which a rental unit is vacant.

FIG. 2 illustrates a system diagram of one embodiment of an occupancy monitoring system for a remote short term housing rental, in which a rental unit is occupied.

### DETAILED DESCRIPTION OF THE INVENTION

The present invention will now be described more fully herein after with reference to the accompanying drawings, which form a part hereof, and which show, by way of illustration, specific exemplary embodiments by which the invention may be practiced. This invention may, however, be embodied in many different forms and should not be construed as limited to the exemplary embodiments set forth herein. Rather, these exemplary embodiments are provided so that this disclosure will be thorough and complete, and will fully convey the scope of the invention to those skilled in the art. Among other things, the present invention may be embodied as methods or devices. Accordingly, various exemplary embodiments may take the form of an entirely hardware embodiments, an entirely software embodiment and/or an embodiment combining software and hardware aspects. The following detailed description is, therefore, not to be taken in a limiting sense.

Throughout the specification and claims, the following terms take the meanings explicitly associated herein, unless the context clearly otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

The following briefly describes the embodiments of the invention in order to provide a basic understanding of some aspects of the invention. This brief description is not intended as an extensive overview. It is not intended to identify key or critical elements, or to delineate or otherwise narrow the scope, its purpose is merely to present some concepts in a simplified form as a prelude to the more detailed description that is presented later.

The present invention, generally, is directed towards providing a monitor to determine a rental status, including but not limited to, occupied and vacant, in order for the owner to keep a solid track record of a daily rental status of the property.

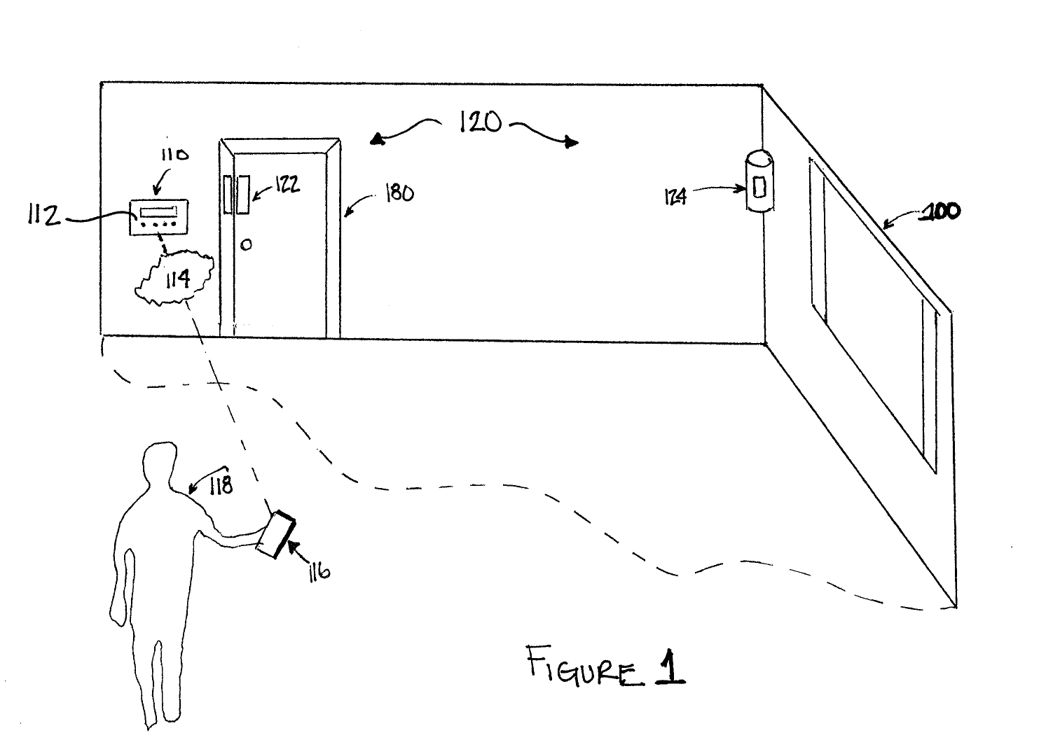

FIG. 1 illustrates a rental unit 100, with a rental status monitor 110. The system in which the rental status monitor operates effectively can include, but is not limited to, for illustrative purposes only: a main panel 112 which can monitor the rental unit 100 and can connect through a wireless and/or hard wired network 114, a sensing unit 120 which can optionally include at least one door sensor 122 and at least one motion sensor 124.

In once exemplary embodiment, as shown in FIG. 1, rental unit 100 can be vacant with a main door 180 closed and secured. In this example, if elements of sensing unit 120, at least one door sensor 120 and at least one motion sensor 124, remain undisturbed, main panel 112 can communicate via network 114, with at least one portable computing device 116 operated by a user 118.

Main panel 112 can comprise any number of interchangeable elements and components which create a functional and visually pleasing display features for a user 118. In one exemplary embodiment of main panel 112, functionally necessary elements and components may include, but are not limited to, a transceiver configured to send and receive the status signal to at least one portable computing device via the network, a sensing unit configured to detect and analyze a dwelling to determine occupancy, and a controller configured to verify the detected occupancy.

The controller, upon detection and analysis of the occupancy by the sensing unit, can verify the detected occupancy by evaluating at least one detected sound or at least one detected volume, can identify an occupancy status based on the evaluation, and can create the status signal based on the identification. The controller may then authorize the transceiver to send the status signal to the at least one portable computing device.

Sensing unit 120 can optionally include a number of additional elements, for example, an audio detector which can be configured to detect at least one audio tone created within the dwelling where the rental status monitor is located, and/or an audio recognizer which can be configured to identify the at least one audio tone as a tone from a human or animal.

The audio recognizer can be configured to identify the at least one audio tone as a tone from a human or animal and can further comprise a number of interchangeable computer executable instructions, for example, analyzing a detected audio tone for at least one spatio-temporal property compared to a library of spatio-temporal property audio tones, comparing the detected audio tone to a library of attack vectors to determine if an active deception is occurring, creating a positive status signal if comparisons determine a human or animal and also creating a positive status signal if comparisons determine an active deception, and creating a negative status signal if comparisons determine no audio tone which is at least one spatio-temporal property of a human or animal.

Spatio-temporal properties are commonly observable characteristic traits of humans and animals, for example, presence, count, location, track, and identity. These properties can be observed by measuring specific human traits through a number of sensing modalities, such as door sensor 122 and/or motion sensor 124.

In this exemplary embodiment, the audio detector comprises one or more sensing elements which can be removably attached to physical elements within the dwelling. For example, audio detector can be removably attached in a same or different location than door sensor 122 and/or motion sensor 124.

In additional embodiments of the main panel 112, sensing unit 120 can further comprise a volume detector which can be configured to detect at least one volume located within the dwelling where the rental status monitor is located and a volume recognizer configured to identify the at least one volume as a volume created from a human or animal.

In these exemplary embodiments, the volume recognizer can be configured to identify the at least one volume of a human or animal, further comprising analyzing a detected volume for at least one spatio-temporal property attributed to a human or animal compared to a library of spatio-temporal property volumes, comparing the detected volume to a library of attack vectors to determine if an active deception is occurring, and creating a positive status signal if comparisons determine a human or animal and also creating a positive status signal if comparisons determine an active deception.

Furthermore, in these exemplary embodiments, a negative status signal may be created if comparisons determine no volume which is at least one spatio-temporal property of a human or animal. Additionally, the volume detector can comprise one or more sensing elements which are removably attached to physical elements within the dwelling, in the same and/or different locations than door detector 122 and/or motion detector 124.

Additionally, rental status monitor 110 can further comprise a processor that is configured to communicate with the at least one portable computing device via the network. Also, rental status monitor 110 can further comprise a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols.

Main panel 112 can further include a number of additional computing device functionality (that are not shown for illustrative purposes). For example, main panel may include a mass memory for storage of data. Mass memory can optionally include a RAM, a ROM, and other storage means. Mass memory illustrates an example of computer readable storage media (devices) for storage of information such as computer readable instructions, data structures, program nodules or other data. Mass memory stores a basic input/output system (“BIOS”) for controlling low-level operation of at least one portable computing device 116. The mass memory also stores an operating system for controlling the operation of client device. It will be appreciated that this component may include a general-purpose operating system such as a version of UNIX, or LINUX™, or a specialized client communication operating system such as Windows Mobile™, or the Symbian® operating system. The operating system may include, or interface with Java virtual machine module that enables control of hardware components and/or operating systems operations via Java application programs.

For example, one exemplary set of interchangeable computer executable instructions which may be stored in mass memory of main panel 112 may include detecting an at least one audio tone or an at least one volume within a dwelling where the rental status monitor is located.

Another exemplary action which the computer executable instruction can cause a rental status monitor to perform can include verifying and analyzing the at least one audio tone or the at least one volume, identifying the at least one audio tone or the at least one volume as having at least one spatio-temporal property of a human or an animal, configuring a status signal from identified at least one audio tone or the at least one volume such that it is transmittable to at least one or more user devices via a network, and sending and receiving the at least status signal to and from the at least one or more user devices and the rental status monitor via the network.

Additional and/or further exemplary computer executable instructions which may be stored on the mass memory of main panel 112 may interchangeably include detecting the at least one audio tone which can further comprise analyzing a detected audio tone for at least one spatio-temporal property compared to a library of spatio-temporal property audio tones, comparing the detected audio tone to a library of attack vectors to determine if an active deception is occurring, and creating a positive status signal if comparisons determine a human or animal and also creating a positive status signal if comparisons determine an active deception; creating a negative status signal if comparisons determine no audio tone which is at least one spatio-temporal property of a human or animal.

In another exemplary embodiment, detecting the at least one volume can further comprise analyzing a detected volume for at least one spatio-temporal property attributed to a human or animal compared to a library of spatio-temporal property volumes, comparing the detected volume to a library of attack vectors to determine if an active deception is occurring, creating a positive status signal if comparisons determine a human or animal and also creating a positive status signal if comparisons determine an active deception, and creating a negative status signal if comparisons determine no volume which is at least one spatio-temporal property of a human or animal.

Additionally, configuring the status signal in another exemplary embodiment can further comprise modulating the audio tone to a digital signal which is transmittable via a network, or reconfiguring a volume image to a digital signal which is transmittable via a network, and transmitting the status signal as one of a plurality of status signals to and from an intermediate computing device, the at least one or portable computing devices, and the rental status monitor via the network.

Furthermore, in additional exemplary embodiments, sending and receiving the status signal to the at least one or more portable computing devices and the rental status monitor via the network can further comprise a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols.

In yet still additional exemplary embodiments, sending and receiving the status signal to the at least one or more portable computing devices and the rental status monitor via the network can further comprise a transceiver configured to communicate wirelessly using at least one infrared frequency, said transceiver configured to send and receive the status signal according to IrDA-SIR, IrDA-MIR, and IrDA-FIR protocols.

In yet further exemplary embodiments, sending and receiving the status signal to the at least one or more portable computing devices and the rental status monitor via the network can further comprise a transceiver configured to authenticate wirelessly, and can further comprise encrypting the at least status signal, initiating wireless communication with a wireless communication device, authenticating the wireless communication device using a private authentication key to authenticate the user's identity, identify the originating source of the status signal to determine if an active deception is occurring; and sending the encrypted status signal upon positive authentication of the wireless communication device.

In yet still additional exemplary embodiments, verifying and analyzing the at least one data item entered by the user further comprises comparing the detected audio tone or the detected volume to a matrices of stored data libraries, wherein the matrices of stored data libraries can further comprise audio tones and volumes which correlate to spatio-temporal properties of a human or animal, stored so that all information is accessible to the controller at such time that the detecting units senses said audio tone or said volume.

Additionally, configuring the status signal such that it is transmittable to the at least one or more portable computing devices via the network in additional exemplary embodiments can further comprise storing the at least one data item to a memory in the rental status monitor. Also, sending and receiving the status signal to and from the at least one or more portable computing devices and the rental status monitor via the network can further comprise transmitting a communication with the transmitted status signal that is displayed on the one or more portable computing devices as a GPS location of the audio tone or volume, based on at least one collected geographic data collected by the sensing unit.

Memory may further include one or more data storage, which can be utilized by at least one portable computing device 116 to store, among other things, applications and/or other data. For example, data storage may also be employed to store information that describes various capabilities of at least one portable computing device 116. The information may then be provided to another device based on any of a variety of events, including being sent as part of a header during a communication, sent upon request, or the like.

Applications may include computer executable instructions which, when executed by at least one portable computing device 116, transmit, receive, and/or otherwise process data (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications may include, for example, browser and at least one general internet application.

Network 114 can be configured to couple the at least one portable computing device(s) 116 with main panel 112 as well as other computing devices. Network 114 can be enabled to employ any form of computer readable media for communicating information from one electronic device to another. Also, network 114 can include the Internet in addition to local area networks (LANs) and wide area networks (WANs), direct connections, such as, for example, through a universal serial bus (USB) port, other forms of computer-readable media, or any combination thereof. On an interconnected set of LANs, including those based on differing architectures and protocols, a router acts as a link between LANs, enabling data communication to be sent from one to another. In addition, data communication links within LANs typically include twisted wire pair or coaxial cable, while data communication links between networks may utilize analog telephone lines, full or fractional dedicated digital lines including T1, T2, T3 and T4, Integrated Services Digital Networks (ISDNs), Digital Subscriber Lines (DSLs), wireless links including, but not limited to satellite links, or other communications links known to those skill in the art. Furthermore, remote computers and other related electronic devices could be remotely connected to either LANs or WANs via a modem and temporary telephone link. In essence, network 114 includes any communication method by which information may travel between computing devices.

Network 114 can also be a wireless network, and can include any of a variety of wireless sub-networks that may future overall stand-alone ad-hoc networks, and the like, to provide an infrastructure-oriented connection for the at least portable computing device(s) 116. Such sub-networks may include mesh networks, wireless LAN (WLAN) networks, cellular networks, and any other format of wireless connection.

Network 1114 can further include an autonomous system of terminals, gateways, routers, and the like connected by wireless radio links, and similar. These connectors can be configured to move freely and randomly and organize themselves arbitrarily, such that the topology of network 114 may change rapidly.

Network 114 may further employ a plurality of access technologies including second (2G), third (3G) generation radio access for cellular systems, Code Division Multiple Access (CDMA), WLAN, Wireless Router (WR) mesh, and similar configurations. Access technologies such as 2G, 3G and future access network may enable wide area coverage for mobile devices, such as embodiments of at least one portable computing device 116, with various degrees of mobility. For example, network 114 may enable a radio connection through a radio network access such as Global System for Mobil Communication (GSM), General Packet Radio Services (GPRS), Enhanced Data GSM Environment (EDGE), Wideband Code Division Multiple Access (WCDMA), and similar. In essence, network 114 may include virtually any wireless communication mechanism by which information may travel between at least one portable computing device 116 and another computing device, network or similar.

At least one portable computing device 116 can include, for example, a variety of interchangeable elements, all of which may not be necessary for functional operation of said at least one portable computing device, but which may be beneficial for a user 118. For example, at least one portable computing device 116 can include elements, such as but not limited to, a processing unit (CPU) in communication with a mass memory via a bus 224; a power supply, one or more network interfaces, an audio interface, a display, a keypad, an illuminator, an input/output interface, a haptic interface, and a global positioning systems (GPS) receiver. Power supply provides power to at least one portable computing device 116. A rechargeable or non-rechargeable battery may be used to provide power. The power may also be provided by an external power source, such as an AC adapter or a powered docking cradle that supplements and/or recharges a battery.

At least one portable computing device 116 may also optionally communicate with a base station or directly with another computing device. Network interface includes circuitry for coupling at least one portable computing device 116 to one or more networks, such as network 114, and is constructed for use with one or more communication protocols and technologies including, but not limited to, global system for mobile communication (GSM), code division multiple access (CDMA), time division multiple access (TDMA), user datagram protocol (UDP), transmission control protocol/Internetprotocol (TCP/IP), SMS, general packet radio service (GPRS), WAP, ultra wide band (UEB), IEEE 8022.16 Worldwide Interoperability for Microwave Access (WiMax), SIP/RTP, or any of a variety of other wireless communication protocols,

Network interface is sometimes known as a transceiver, transceiving device, or network interface card (NIC).

Audio interface can be arranged to produce and receive audio signals such as sound of a human voice. For example, audio interface may be coupled to a speaker and microphone (not shown) to enable telecommunication with other and/or generate an audio acknowledgement for some action. Display may be a liquid crystal display (LCD), gas plasma, light emitting diode (LED), or any other type of display used with a computing device. Display may also include a touch sensitive screen arranged to receive input from an object such as a stylus or a digit from a human hand.

Keypad may comprise any input device arranged to receive input from a user. For example, keypad 256 may include a push button numeric dial, or a keyboard. Keypad may also include command buttons that are associated with selecting and sending images. Illuminator may remain provide a status indication and/or provide light. Illuminator may remain active for specific periods of time or in response to events. For example, when illuminator may backlight these buttons in various patterns when particular actions are performed, such as dialing another client device. Illuminator may also cause light sources positioned within a transparent or translucent case of the client device to illuminate in response to actions.

At least one portable computing device 116 may also comprise input/output interface for communicating with external devices, such as a headset, or other input or output devices. Input/output interface can utilize one or more communication technologies, such as USB, infrared, Bluetooth™, or the like. Haptic interface may be employed to vibrate at least one portable computing device 116 in a particular way when another user of a computing device is calling.

A GPS transceiver can determine the physical coordinates of at least one portable computing device 116 on the surface of the Earth, which typically outputs a location as latitude and longitude values. Furthermore, a GPS transceiver can also be located within main panel 112 determine the physical coordinates of the monitoring system, or optionally any detected entity located with said dwelling. GPS transceiver can also employ other geo-positioning mechanisms, including, but not limited to, triangulation, assisted GPS (AGPS), E-OTD, CI, SAT, ETA, BSS or the like, to further determine the physical location of at least one portable computing device 116 on the surface of the Earth. It is understood that under different conditions, GPS transceiver 264 can determine a physical location within millimeters for at least one portable computing device 116; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory can optionally include a RAM, a ROM, and other storage means. Mass memory illustrates an example of computer readable storage media (devices) for storage of information such as computer readable instructions, data structures, program nodules or other data. Mass memory stores a basic input/output system (“BIOS”) for controlling low-level operation of at least one portable computing device 116. The mass memory also stores an operating system for controlling the operation of client device. It will be appreciated that this component may include a general-purpose operating system such as a version of UNIX, or LINUX™, or a specialized client communication operating system such as Windows Mobile™, or the Symbian® operating system. The operating system may include, or interface with Java virtual machine module that enables control of hardware components and/or operating systems operations via Java application programs.

Memory may further include one or more data storage, which can be utilized by at least one portable computing device 116 to store, among other things, applications and/or other data. For example, data storage may also be employed to store information that describes various capabilities of at least one portable computing device 116. The information may then be provided to another device based on any of a variety of events, including being sent as part of a header during a communication, sent upon request, or the like.

Applications may include computer executable instructions which, when executed by at least one portable computing device 116, transmit, receive, and/or otherwise process data (e.g., SMS, MMS, IM, email, and/or other messages), audio, video, and enable telecommunication with another user of another client device. Other examples of application programs include calendars, search programs, email clients, IM applications, SMS applications, VOIP applications, contact managers, task managers, transcoders, database programs, word processing programs, security applications, spreadsheet programs, games, search programs, and so forth. Applications may include, for example, browser and at least one general internet application.

Browser may include virtually any application configured to receive and display graphics, text, multimedia, and the like, employing virtually any web based language. In one embodiment, the browser application is enabled to employ Handheld Device Markup Language (HDML), Wireless Markup Language (WML), WMLScript, JavaScript, Standard Generalized Markup Language (SMGL), HyperTest Markup Language (HTML), eXtensible Markup Language (XML), and the like, to display and send a message. However, any of a variety of other web-based languages may be employed.

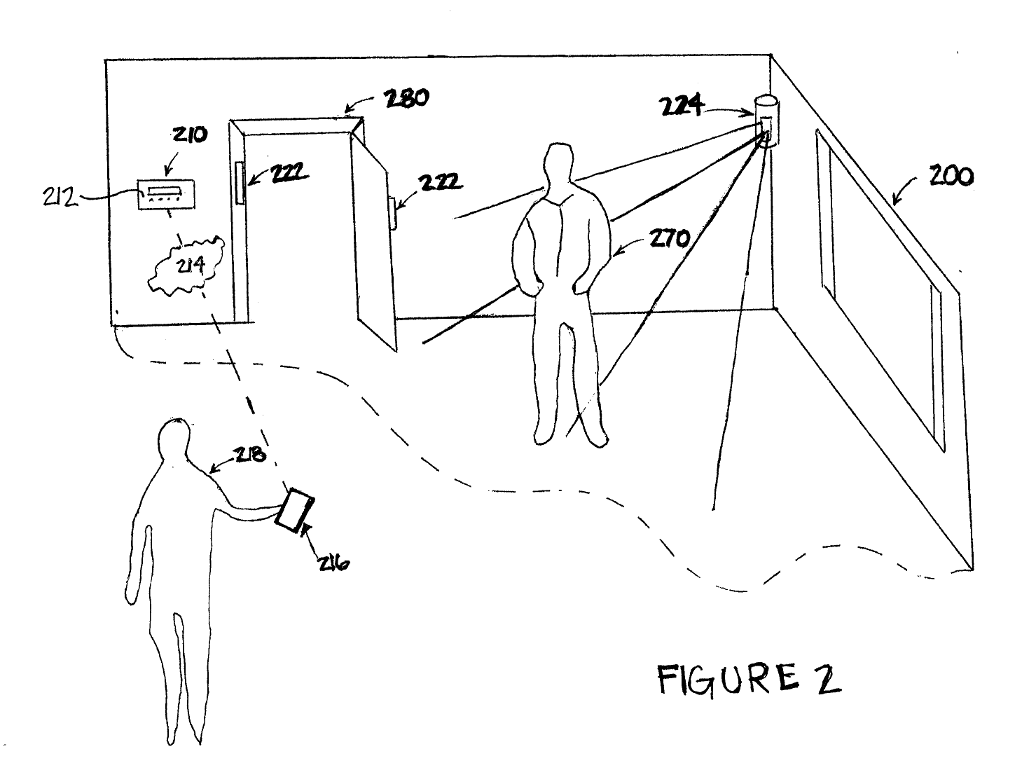

FIG. 2 illustrates a second embodiment of a rental unit monitoring system 210 is depicted for illustrative purposes. In FIG. 2, is a rental unit 200, with a monitoring system 210 installed, which consists of main panel 212. Main panel 212 may be constantly monitoring in a manner as described above with reference to FIG. 1. Main unit 212 may connect through a wireless and/or hard-wired network 214.

Main panel 212 may further comprise at least one door sensor 222 and at least one motion sensor 124. In the illustrative example depicted in FIG. 2, rental unit 200 is occupied by a user 270. For illustrative purposes, user 270 in this example may be a tenant or a tenant guest. If user 270 opens a main door 280, at least one door sensor 222 sends a signal via network 214 to main panel 212. Optionally, at least one motion sensor 224 can be activated by user 270 which may also optionally alert main panel 212.

Main panel 212 thereafter can communicate via network 214 with at least one portable computing device 216, operated by a user 218, as described in more detail above with reference to FIG. 1.

Additional methods, aspects and elements of the present inventive concept are contemplated in use in conjunction with individually or in any combination thereof which will create a reasonably functional system to be of use as a rental status monitoring system to determine occupancy in a short term rental unit. Methods of use are also contemplated using all optional aspects and embodiments as described above, individually or in combination thereof.

It will be apparent to one of ordinary skill in the art that the manner of making and using the claimed invention has been adequately disclosed in the above-written description of the exemplary embodiments and aspects. It should be understood, however, that the invention is not necessarily limited to the specific embodiments, aspects, arrangement and components shown and described above, but may be susceptible to numerous variations within the scope of the invention.

Moreover, particular exemplary features described herein in conjunction with specific embodiments and/or aspects of the present invention are to be construed as applicable to any embodiment described within, enabled thereby, or apparent wherefrom. Thus, the specification and drawings are to be regarded in a broad, illustrative, and enabling sense, rather than a restrictive one.

Further, it will be understood that the above description of the embodiments of the present invention are susceptible to various modifications, changes, and adaptations, and the same are intended to be comprehended within the meaning and range of equivalents of the appended claims.

What is claimed is:

1. A system, comprising:
a network;
a rental status monitor located within a dwelling; and
at least one portable computing device;
wherein the rental status monitor communicates a status signal via the network to the portable computing device to alert a user of a status of occupancy of a dwelling.

2. The system of claim 1, wherein the rental status monitor further comprises:
a transceiver configured to send and receive the status signal to at least one portable computing device via the network;
a sensing unit configured to detect and analyze a dwelling to determine occupancy; and
a controller configured to verify the detected occupancy;
wherein the controller, upon detection and analysis of the occupancy by the sensing unit, verifies the detected occupancy by evaluating at least one detected sound or at least one detected volume, identifying an occupancy status based on the evaluation, and creating the status signal based on the identification; and wherein the controller authorizes the transceiver to send the status signal to the at least one portable computing device.

3. The system of claim 2, wherein the sensing unit further comprises:
an audio detector which is configured to detect at least one audio tone created within the dwelling where the rental status monitor is located; and
an audio recognizer configured to identify the at least one audio tone as a tone from a human or animal.

4. The system of claim 3, wherein the audio recognizer is configured to identify the at least one audio tone as a tone from a human or animal, further comprising:
analyzing a detected audio tone for at least one spatio-temporal property compared to a library of spatio-temporal property audio tones;
comparing the detected audio tone to a library of attack vectors to determine if an active deception is occurring;
creating a positive status signal if comparisons determine a human or animal and also creating a positive status signal if comparisons determine an active deception; and
creating a negative status signal if comparisons determine no audio tone which is at least one spatio-temporal property of a human or animal.

5. The system of claim 3, wherein the audio detector comprises one or more sensing elements which are removably attached to physical elements within the dwelling.

6. The system of claim 2, wherein the sensing unit further comprises:
a volume detector configured to detect at least one volume located within the dwelling where the rental status monitor is located; and
a volume recognizer configured to identify the at least one volume as a volume created from a human or animal.

7. The system of claim 6, wherein the volume recognizer is configured to identify the at least one volume of a human or animal, further comprising:
analyzing a detected volume for at least one spatio-temporal property attributed to a human or animal compared to a library of spatio-temporal property volumes;
comparing the detected volume to a library of attack vectors to determine if an active deception is occurring;
creating a positive status signal if comparisons determine a human or animal and also creating a positive status signal if comparisons determine an active deception; and
creating a negative status signal if comparisons determine no volume which is at least one spatio-temporal property of a human or animal.

8. The system of claim 6, wherein the volume detector comprises one or more sensing elements which are removably attached to physical elements within the dwelling.

9. The system of claim 1, wherein the rental status monitor further comprises a processor that is configured to communicate with the at least one portable computing device via the network.

10. The system of claim 1, wherein the rental status monitor further comprises a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols.

11. A non-transitory computer readable storage medium having computer executable instructions, the computer executable instructions when installed onto a rental status monitor cause the rental status monitor to perform actions, comprising:
detecting an at least one audio tone or an at least one volume within a dwelling where the rental status monitor is located;
verifying and analyzing the at least one audio tone or the at least one volume;
identifying the at least one audio tone or the at least one volume as having at least one spatio-temporal property of a human or an animal;
configuring a status signal from identified at least one audio tone or the at least one volume such that it is transmittable to at least one or more user devices via a network; and
sending and receiving the at least status signal to and from the at least one or more user devices and the rental status monitor via the network.

12. The non-transitory computer readable storage medium having computer executable instructions, the computer executable instructions of claim 11, enabling the rental status monitor to perform actions, wherein detecting the at least one audio tone further comprises:
analyzing a detected audio tone for at least one spatio-temporal property compared to a library of spatio-temporal property audio tones;
comparing the detected audio tone to a library of attack vectors to determine if an active deception is occurring;
creating a positive status signal if comparisons determine a human or animal and also creating a positive status signal if comparisons determine an active deception;
creating a negative status signal if comparisons determine no audio tone which is at least one spatio-temporal property of a human or animal.

13. The non-transitory computer readable storage medium having computer executable instructions, the computer executable instructions of claim 11, enabling the rental status monitor to perform actions, wherein detecting the at least one volume further comprises:
analyzing a detected volume for at least one spatio-temporal property attributed to a human or animal compared to a library of spatio-temporal property volumes;
comparing the detected volume to a library of attack vectors to determine if an active deception is occurring;
creating a positive status signal if comparisons determine a human or animal and also creating a positive status signal if comparisons determine an active deception; and
creating a negative status signal if comparisons determine no volume which is at least one spatio-temporal property of a human or animal.

14. The non-transitory computer readable storage medium having computer executable instructions, the computer executable instructions of claim 11, enabling the rental status monitor to perform actions, wherein configuring the status signal further comprises:
modulating the audio tone to a digital signal which is transmittable via a network; or
reconfiguring a volume image to a digital signal which is transmittable via a network; and
transmitting the status signal as one of a plurality of status signals to and from an intermediate computing device, the at least one or portable computing devices, and the rental status monitor via the network.

15. The non-transitory computer readable storage medium having computer executable instructions, the computer executable instructions of claim 11, enabling the rental status monitor to perform actions, wherein sending and receiving the status signal to the at least one or more portable computing devices and the rental status monitor via the network further comprises:
a transceiver configured to communicate wirelessly using at least one radio frequency, said transceiver configured to send and receive the status signal according to IEEE 802.11 a, b, g, 2007, n, 2012, ac, ad, of and ah protocols and IEEE 802.15.1 protocols.

16. The non-transitory computer readable storage medium having computer executable instructions, the computer executable instructions of claim 11, enabling the rental status monitor to perform actions, wherein sending and receiving the status signal to the at least one or more portable computing devices and the rental status monitor via the network further comprises:
a transceiver configured to communicate wirelessly using at least one infrared frequency, said transceiver configured to send and receive the status signal according to IrDA-SIR, IrDA-MIR, and IrDA-FIR protocols.

17. The non-transitory computer readable storage medium having computer executable instructions, the computer executable instructions of claim 11, enabling the rental status monitor to perform actions, wherein sending and receiving the status signal to the at least one or more portable computing devices and the rental status monitor via the network further comprises:
a transceiver configured to authenticate wirelessly, comprising:
encrypting the at least status signal;
initiating wireless communication with a wireless communication device;
authenticating the wireless communication device using a private authentication key to authenticate the user's identity, identify the originating source of the status signal to determine if an active deception is occurring; and
sending the encrypted status signal upon positive authentication of the wireless communication device.

18. The non-transitory computer readable storage medium having computer executable instructions, the computer executable instructions of claim 11, enabling the rental status monitor to perform actions, wherein verifying and analyzing the at least one data item entered by the user further comprises comparing the detected audio tone or the detected volume to a matrices of stored data libraries, wherein the matrices of stored data libraries further comprise audio tones and volumes which correlate to spatio-temporal properties of a human or animal, stored so that all information is accessible to the controller at such time that the detecting units senses said audio tone or said volume.

19. The non-transitory computer readable storage medium having computer executable instructions, the computer executable instructions of claim 11, enabling the rental status monitor to perform actions, wherein configuring the status signal such that it is transmittable to the at least one or more portable computing devices via the network further comprises storing the at least one data item to a memory in the rental status monitor.

20. The non-transitory computer readable storage medium having computer executable instructions, the computer executable instructions of claim 11, enabling the rental status monitor to perform actions, wherein sending and receiving the status signal to and from the at least one or more portable computing devices and the rental status monitor via the network further comprises transmitting a communication with the transmitted status signal that is displayed on the one or more portable computing devices as a GPS location of the audio tone or volume, based on at least one collected geographic data collected by the sensing unit.
